(19) United States
(12) Patent Application Publication
(10) Pub. No.: US 2008/0084579 A1
(43) Pub. Date: Apr. 10, 2008

(54) Image processing apparatus and program

(75) Inventors: Kaitaku Ozawa, Itami-shi (JP); Toshiya Shozaki, Osaka-shi (JP); Junichi Hase, Osaka-shi (JP); Ryuichi Kitaoka, Uji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/905,615

(22) Filed: Oct. 2, 2007

(30) Foreign Application Priority Data
Oct. 9, 2006 (JP) 2006-275889

(51) Int. Cl. G06K 1/00

(52) U.S. Cl. 358/1.15; 358/1.16

(57) ABSTRACT

An image processing apparatus wherein a plural number of optional ways of processing image data are stored in connection with each user, and one of the ways is designated as an initial setting for the user's way of processing image data. The image data are data sent from an exterior device to a specified user or data which a scanning section generated by reading a document image. Each user can change his/her initial setting arbitrarily. Depending on the device which a user logs in and/or the attributes of data, the way of processing data is changed from the initial setting to another of the stored optional ways or to a new way which is different from the initial setting in at least one item. Thereby, each user can receive data in a more convenient way.

This application is based on a Japanese patent application No. 2006-275889 filed on Oct. 9, 2006, of which content is incorporated herewith by reference.

### BACKGROUND OF THE INVENTION

1. Field of the Invention

The present invention relates to an image processing apparatus and a program.

2. Description of Related Art

JP2001-53860A (Reference 1) discloses a communication terminal stored with destination information in connection with each user ID, the destination information specifying a communication terminal in a place the user stays on business. When a user ID is presented, the communication terminal reads out the destination information in connection with the user ID, and data are sent to another communication terminal specified by the destination information.

In the prior art according to Reference 1, a communication terminal in a place where the user will stay on business must be designated beforehand. When a user cannot input information on the destination of a trip in his/her hurry to leave, the communication terminal cannot give full play to provide data for the user.

### SUMMARY OF THE INVENTION

The present invention has been made in view of the problem above. An object of the present invention is to provide an image processing apparatus and a software program which permit a user to receive data in a more convenient way.

In order to attain the object, a first aspect of the present invention provides an image processing apparatus which comprises: an image data receiving section for receiving image data; a storage section stored with processing information in connection with individual users, the processing information in connection with each user including one or more optional ways of processing the image data and specifying one of the optional ways as an initial setting for the user's way of processing the image data; a judging section for judging whether it is necessary to change the way of processing the image data from the initial setting, regardless of a command from the user; and a changing section for changing the way of processing the image data from the initial setting when the judging section judges that it is necessary to change the way of processing the image data.

In the structure above, each user's way of processing the image data can be changed from the initial setting if necessary, and thereby, each user can receive data in a more suited way.

The image processing apparatus may further comprise a log-in detecting section for detecting a user logging in said image processing apparatus or another image processing apparatus connected to said image processing apparatus via a network, and when a user logs in an image processing apparatus other than an image processing apparatus previously specified for the user, the judging section may judge that it is necessary to change the way of processing the image data from the initial setting.

The image processing apparatus may further comprise an attribute information receiving section for receiving attribute information on attributes of the image data received by the image data receiving section, and the judging section may judge from the attribute information whether it is necessary to change the way of processing the image data from the initial setting.

In the image processing apparatus, the changing section may change the way of processing the image data to a more suited way in accordance with the attribute information.

In the image processing apparatus, the changing section may select one, other than the initial setting, from the optional ways included in the processing information and may change the way of processing the image data to the selected way.

In the image processing apparatus, each of the optional ways included in the processing information may contain a plural number of items, and the changing section may change the way of processing the image data to a way by making a change to at least one item of one of the ways. The image processing apparatus may further comprise an entering section for entering the way to which the way of processing the image data is changed into the processing information as a new optional way.

The image processing apparatus may further comprise a logging-in device information receiving section for receiving information on a type of a logging-in device from which a user logs in, and when the logging-in device is a mobile device, the judging section may judge that it is necessary to change the way of processing the image data from the initial setting.

In the image processing apparatus, when the logging-in device is a mobile device, the changing section may change the way of processing the image data to a way of sending e-mail.

In the image processing apparatus, after changing the way of processing the image data from the initial setting, the changing section may return the way of processing the image data to the initial setting when a specified condition is satisfied.

The changing section may return the way of processing the image data to the initial setting when the user logs out.

The changing section may return the way of processing the image data to the initial setting when a specified time has passed since a change of the way of processing the image data from the initial setting.

The changing section may return the way of processing the image data to the initial setting when a specified time has passed since a log-out of the user.

In the image processing apparatus, the image data receiving section may receive image data from an exterior device via a network.

In the image processing apparatus, the one or more optional ways of processing the image data in connection with each user may be one or more optional ways of processing the image data sent from the exterior device to the user.

The image processing apparatus may further comprise a scanner, and the image data receiving section may receive image data which the scanner generated by reading a document image.

In the image processing apparatus, the one or more optional ways of processing the image data in connection with each user may be one or more optional ways of processing the image data which the scanner generated by reading a document image.

A second aspect of the present invention relates to a software program stored on a computer readable medium to be installed in a device with a processor. The device comprises a storage section stored with processing information in connection with individual users, the processing information in connection with each user including one or more optional ways of processing image data and specifying one of the settings as an initial setting for the user's way of processing image data. The software program causes said processor to execute processing comprising: a step of judging whether it is necessary to change the way of processing image data from the initial setting, regardless of a command from the user; and a step of changing the way of processing image data from the initial setting when the judging section judges that it is necessary to change the way of processing the image data.

Thus, in the image processing apparatus according to the present invention, the way of processing image data is changed from the initial setting if necessary, and thereby, each user can receive data in a more convenient way.

### BRIEF DESCRIPTION OF THE DRAWINGS

This and other features of the present invention will be apparent from the following description with reference to the accompanying drawings, in which:

FIG. 1 is a schematic view of a network system according to an embodiment of the present invention;

FIG. 2 is a block diagram showing a hardware structure of an MFP;

FIG. 3 is an illustration showing boxes;

FIG. 4 is a flowchart showing a procedure carried out by an MFP to be newly connected to a network and a procedure carried out by another MFP which is connected to the network;

FIG. 5 is a table showing exemplary terminal information;

FIGS. 6a to 6d are tables showing exemplary user information registered with individual MFPs;

FIG. 7 is a table showing exemplary settings as optional ways of receiving data of a user “David”;

FIG. 8 is a table showing exemplary user data;

FIG. 9 is a flowchart showing an exemplary procedure for changing the way of receiving data;

FIG. 10 is a flowchart showing exemplary detailed processes for judging whether it is necessary to change the way of receiving data;

FIG. 11 is a flowchart showing exemplary detailed processes for changing the way of receiving data;

FIG. 12 is a flowchart showing exemplary detailed processes when a user logs in from a mobile device;

FIG. 13 is an illustration of an exemplary confirmation screen which is displayed on the display section when a selection from the optional ways of receiving data is made;

FIG. 14 is an illustration of an exemplary confirmation screen which is displayed on the display section when a new receiving way is generated;

FIG. 15 is an illustration of another exemplary confirmation screen which is displayed on the display section when a new receiving way is generated;

FIG. 16 is a flowchart showing a procedure according to a second embodiment; and

FIG. 17 is a flowchart showing a procedure for changing the way of receiving data according to the second embodiment.

### DETAILED DESCRIPTION OF THE PREFERRED EMBODIMENTS

Preferred embodiments are hereinafter described with reference to the accompanying drawings. In the embodiments, an MFP (multi-function peripheral) is used as an exemplary image processing apparatus. The MFP is an image processing apparatus incorporating a copying machine, a network printer, a scanner, a facsimile, a document server, etc. Although embodiments which use an MFP will be described below, any other apparatus may be used as long as it has a function of sending image data via a network.

### First Embodiment

### (1) Structure of Network System

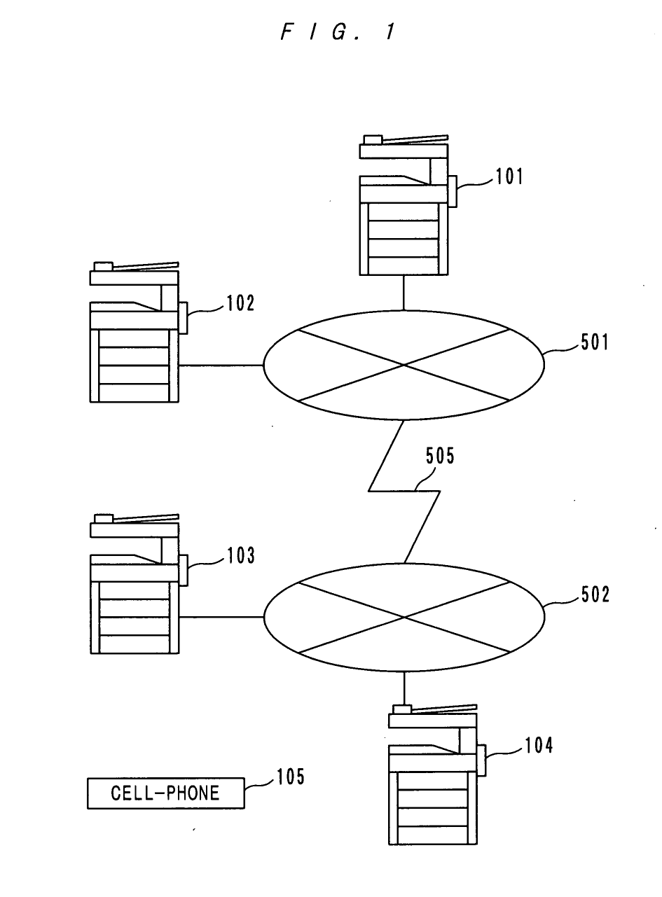

FIG. 1 shows an exemplary structure of a network system according to an embodiment of the present invention. The network system comprises four MFPs. Two of the four MFPs, namely, an MFP 101 and an MFP 102 are connected to a LAN (local area network) 501. The other two MFPs, namely, an MFP 103 and MFP 104 are connected to another LAN 502. The LAN 501 and the LAN 502 are connected to each other via a WAN (wide area network) 505, for example, via an internet, a common carrier leased line or the like, and the four MFPs send and receive data to and from one another via communication lines.

On the WAN 505, a VPN (virtual private network) can be formed. Further, the number of MFPs connected to each LAN can be designed arbitrarily. Also, a cell-phone 105 can log in the network system according to this embodiment.

### (2) Structure of MFPs

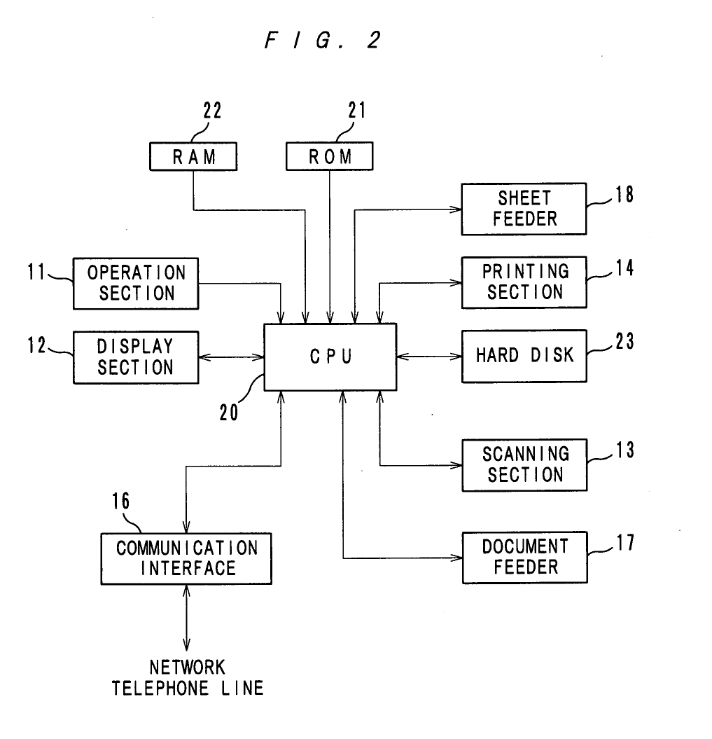

According to this embodiment, the MFPs 101 to 104 are basically of the same structure while having partly different functions. In the following, the structure of the MFP 101 is described as an example. FIG. 2 shows an exemplary hardware structure of the MFP 101.

The MFP 101 comprises an operation section 11, a display section 12, a scanning section 13, a printing section 14, a communication interface 16, a document feeder 17, a sheet feeder 18, a CPU 20, a ROM 21, a RAM 22, a hard disk 23, etc.

The operation section 11 comprises a plural number of keys for inputs of numbers, letters and symbols, a sensor for detecting a key pressed and a circuit for sending a signal showing the pressed key to the CPU 20.

The display section 12 displays screens for presenting information to a user, screens for promoting a user to input for settings and processing, screens for showing the results of processing performed by the MFP 101, etc. In this embodiment, the display section 12 comprises a touch panel, and the touch panel also belongs to the operation section 11. The touch panel detects what area on the touch panel the user touched and sends a signal showing the result of the detection to the CPU 20.

The scanning section 13 reads an image drawn on a document at a specified resolution by irradiating the document and reading the reflected light. Then, the scanning section 13 generates digital image data (here, density data in RGB or in black).

The image data are used for printing at the printing section 14. Also, the image data are transformed into various formats, such as TIFF, PDF, JPEG, etc., and are stored in the hard disk 23. The image data may be transformed into facsimile data and sent by facsimile. In this embodiment, the way of processing image data obtained by reading a document at the scanning section 13 can be set beforehand. The document feeder 17 is located, for example, on the top of the body of the MFP 101 and is used for feeding one or more documents sequentially to the scanning section 13.

The printing section 14 prints out data onto recording sheets of, for example, paper or film. The printed data are data read by the scanning section 13, data sent from an exterior device (e.g. another MFP) via a network (e.g. a LAN) or facsimile data received by facsimile.

The sheet feeder 18 is located, for example, in a lower section of the body of the MFP 101 and feeds recording sheets to the printing section 14. Printed sheets, that is, recording sheets which obtained images thereon at the printing section 14, are ejected on a sheet tray (not shown).

The communication interface 16 is an interface for communications with exterior devices, such as other MFPs, personal computers, the cell-phone 105, etc., via networks such as a LAN, a WAN, etc. and for sending/receiving facsimiles via a telephone line. As the communication interface 16, for example, a NIC (network interface card), a TA (terminal adapter), etc. can be used.

The ROM 21 is stored with programs and data for carrying out the fundamental functions of the MFP 101, such as a function as a scanner, a function as a copying machine, a function as a facsimile, a function as a network printer, a function as a document server (box function), etc. Further, the ROM 21 is stored with a program and data for a function according to the present invention as described below.

All or part of the programs and the data may be stored in the hard disk 23. In this case, the programs and the data stored in the hard disk 23 are loaded to the RAM 22 when necessary.

The function according to this embodiment is not necessarily carried out by the CPU 20 and may be carried out by using a hardware for exclusive use or by partly using a function of a general-purpose program such as an operating system (OS).

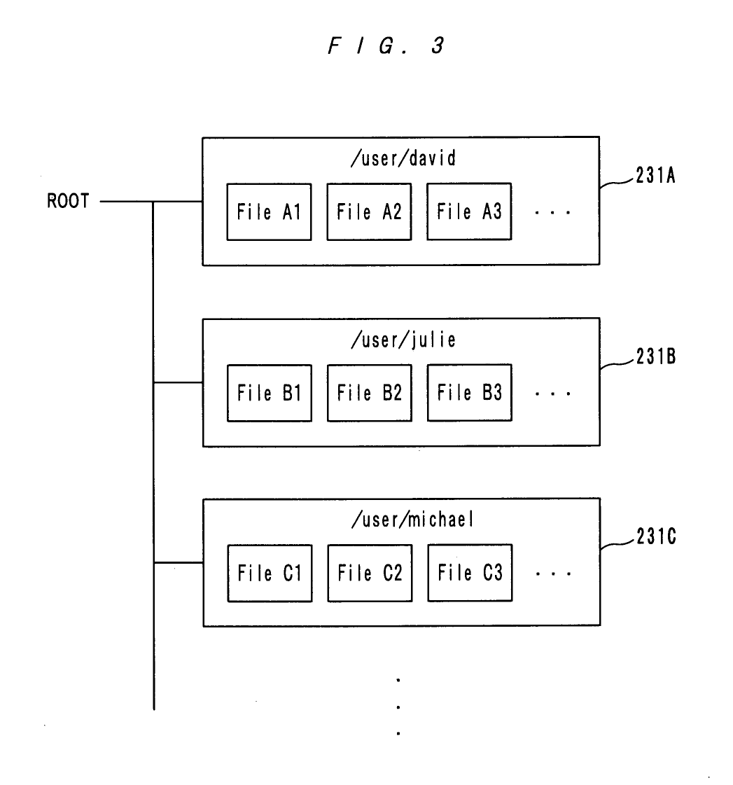

In the hard disk 23, boxes for storing files therein are made. The boxes correspond to folders. FIG. 3 is an illustration showing the boxes. In this embodiment, in the hard disk 23, private boxes 231A, 231B 231C . . . are made for individual users. A public box, to which all the users can make accesses, may be made as well as the private boxes. In each of the boxes, for example, image data files sent from other MFPs are stored.

### (3) Structure of Virtual Sub-Network

In this embodiment, the MFPs 101 to 104, as members of a group, form a virtual sub-network. In the following, the virtual sub-network is described. A virtual sub-network permits a plural number of MFPs in a group to make accesses to one another to get data from one another by previously exchanging necessary information with one another.

The virtual sub-network may be made within a single LAN. Otherwise, like in this embodiment, MFPs connected to different LANs may form a virtual sub-network. In a virtual sub-network, every user has his/her home MFP. In this embodiment, an MFP stored with registration information in connection with a user is the user's “home MFP”. For example, if the MFP 101 is stored with registration information in connection with a user “David”, the home MFP of the user “David” will be the MFP 101.

Suppose that the MFPs 102, 103 and 104 connected to the LAN 501 and 502 as shown by FIG. 1 form a virtual sub-network and that the MFP 101 is to be newly connected to the LAN 501. In the MFP 101, terminal information for distinguishing the MFP 101 itself from the other MFPs in the same group and registration information in connection with users are stored.

After terminal information and registration information are entered in the MFP 101, the MFP 101 sends the terminal information and the registration information to the other MFPs 102, 103 and 104 with reference to the terminal information. Meanwhile, the MFPs 102, 103 and 104 send registration information stored in the respective MFPs 102, 103 and 104 to the MFP 101. With this exchange of information, the terminal information and the registration information are shared by the MFPs in the group.

In this embodiment, because a group of MFPs are formed between a plural number of networks (the LANs 501 and 502), the MFP 101 is previously provided with IP addresses of the other MFPs in the group. When a virtual sub-network is formed within a LAN, however, it is possible to obtain terminal information from other MFPs in the group via a broadcast packet. With the exchange of terminal information and registration information among the MFPs 101 to 104, a virtual sub-network is formed among the MFPs 101 to 104.

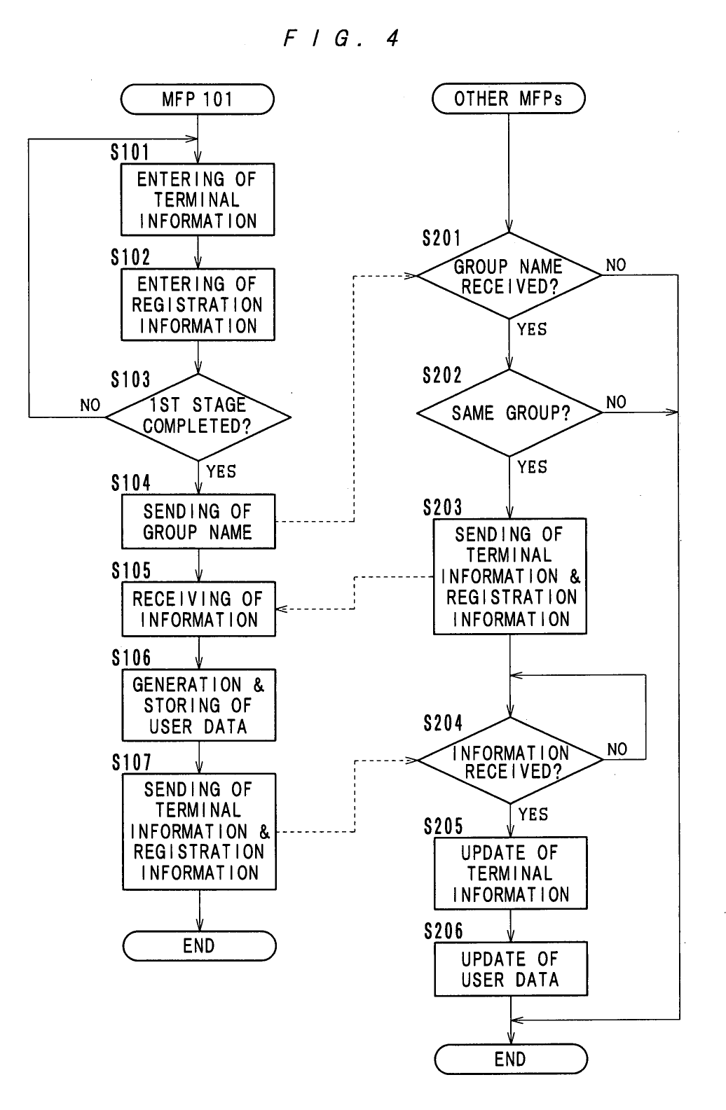

Processing for forming a virtual sub-network is specifically described below. FIG. 4 is a flowchart showing a procedure carried out by the MFP 101 which is to newly join in a virtual sub-network and a procedure carried out by the other MFPs in the virtual sub-network.

First, terminal information is entered in the MFP 101 (step S101). In this embodiment, the terminal information includes information for identifying the MFP 101, the name of a group to which the MFP 101 belongs and information on the other MFPs in the group. The terminal information is preferably information showing positions of the individual MFPs in the network and is, for example, IP addresses of the MFPs. FIG. 5 shows exemplary terminal information.

Next, registration information in connection with a user is entered in the MFP 101 (step S101) so that the user can use the MFP 101 as his/her home MFP 101. When a plural number of users wish to use the MFP 101 as their home MFP, registration information in connection with all the individual users is entered.

The registration information on each user includes a user ID, which is a code peculiar to the user. In this embodiment, the ID of a user is the user's name. The registration information on each user includes private information on the user. The private information is, for example, information on privacy, an address note, information on panel settings, authentication information and history information.

The private information is used to improve the operability of MFPs in a virtual sub-network. Specifically, when a user logs in the virtual sub-network from an MFP other than his/her home MFP, the private information permits the user to operate the MFP in the same way as operating his/her home MFP.

The terminal information and the registration information are inputted by users' operations at the operation section 11. Specifically, a terminal information input screen and a registration information input screen are displayed on the display section 12, and users input necessary information by operating the operation section 11 following instructions displayed on the screens. Generally, the terminal information is inputted by an administrator, while the registration information is inputted by individual users.

Thereafter, it is judged whether the first stage of entering terminal information and registration information in the MFP 101 has been completed (step S103). When the first stage has not been completed, the processing returns to step S101. On completion of the first stage (YES at step S103), the MFP 101 sends a group name to the other MFPs (step S104).

Each of the other MFPs (MFP 102, etc.) receives a group name from the MFP 101 (YES at step S201) and judges whether the group name received is identical with a group name stored therein (step S202).

When the group name received is identical with the group name stored therein (YES at step S202), each of the other MFPs sends registration information stored therein to the MFP 101 (step S203). If the group name received is different from the group name stored therein (NO at step S202), the MFP does not send registration information stored therein to the MFP 101.

The MFP 101 receives information from the other MFPs (MFPs 102 to 104) in the group (step S105), and the MFP 101 generates user data and stores the user data therein (step S106). Then, the MFP 101 sends the registration information which was entered therein at step S102 to the other MFPs in the group (step S107).

Each of the other MFPs receives the registration information from the MFP 101 (YES at step S204) and updates the terminal information stored therein so as to record information on the MFP 101 (step S205). Specifically, all the MFPs in the group have the terminal information as shown by FIG. 5, and the IP address of the MFP 101 is added to the terminal information. Then, each of the other MFPs updates user data stored therein to add registration information sent from the MFP 101 to the user data (step S206). The update of the terminal information in each of the other MFPs may be executed immediately after each of the other MFPs judges that the group name received at step S201 is identical with the group name stored therein (YES at step S202).

As described, the user data generated in the MFP 101 and in each of the other MFPs are the total data of the terminal information and the registration information stored in the MFPs 101 to 104, and the user data include the terminal information on the individual MFPs and user identifiers. The user data generated at the individual MFPs are stored in the respective hard disks. In this way, the MFPs 101 to 104 have the same user data.

As described, terminal information and registration information are entered at the first stage of the procedure carried out by the MFP 101. Also, after the MFP 101 joined in a virtual sub-network, when a new user makes a registration with the MFP 101, a similar process is executed. At this time, the entering of terminal information at step S101 is not necessary.

Also, the processes for entering of terminal information and registration information may be executed every time each of the MFPs is turned on or at regular time intervals. With this arrangement, for example, when a new user makes a registration with one of the MFPs 102 to 104, the MFP 101 can obtain registration information on the new user and can update the user data stored therein. At this time, instead of the processes at steps S101 to S103, the MFP 101 sends a request to the other MFPs 102 to 104 in the same group to request the other MFPs 102 to 104 for registration information.

In response to the registration information request, the other MFPs 102 to 104 execute the processing shown by FIG. 4 and send the registration information stored in the respective hard disks to the MFP 101. Thus, when the registration information stored in one of the MFPs 102 to 104 is updated, the MFP 101 can update the user data stored in the hard disk 23 in accordance with the update of the registration information made in one of the other MFPs 102 to 104.

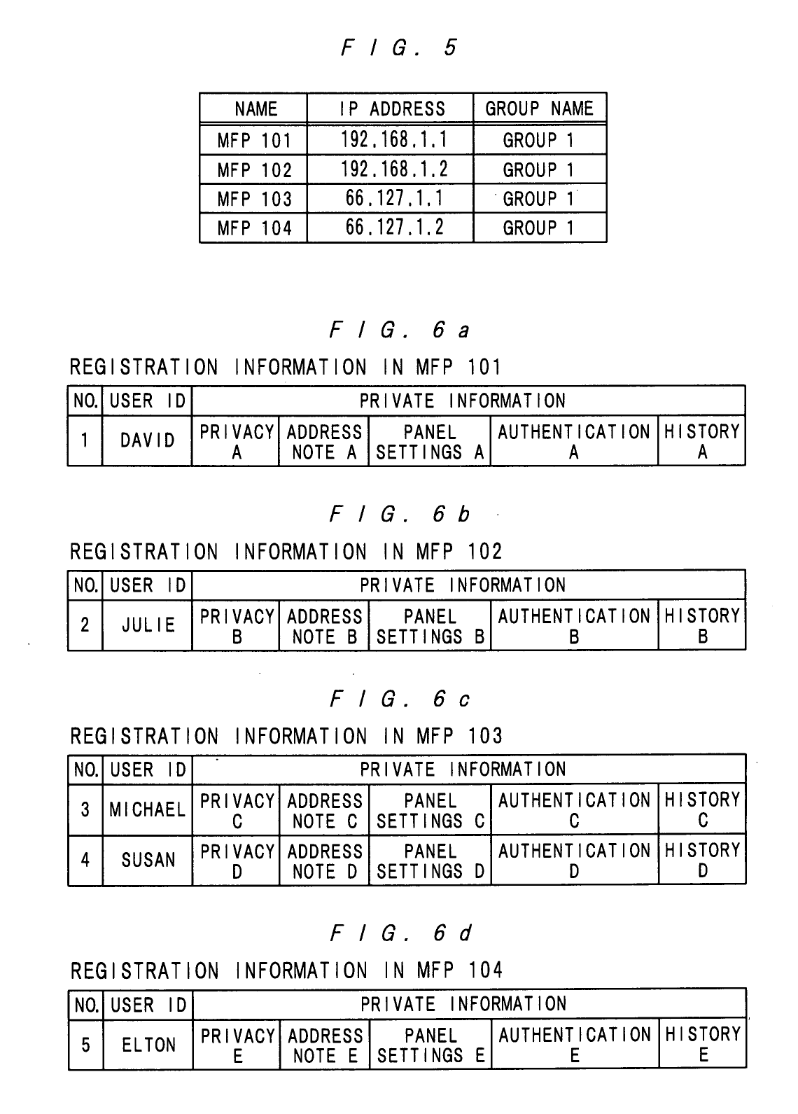

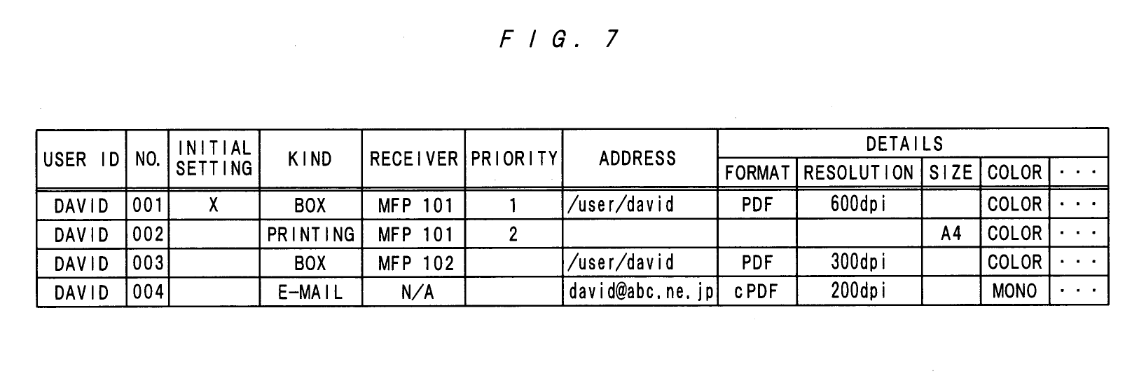

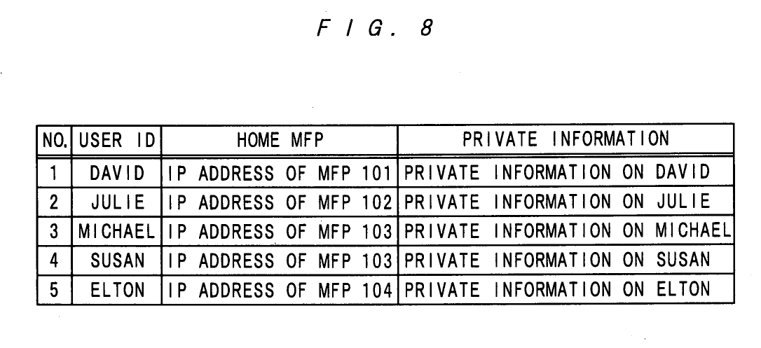

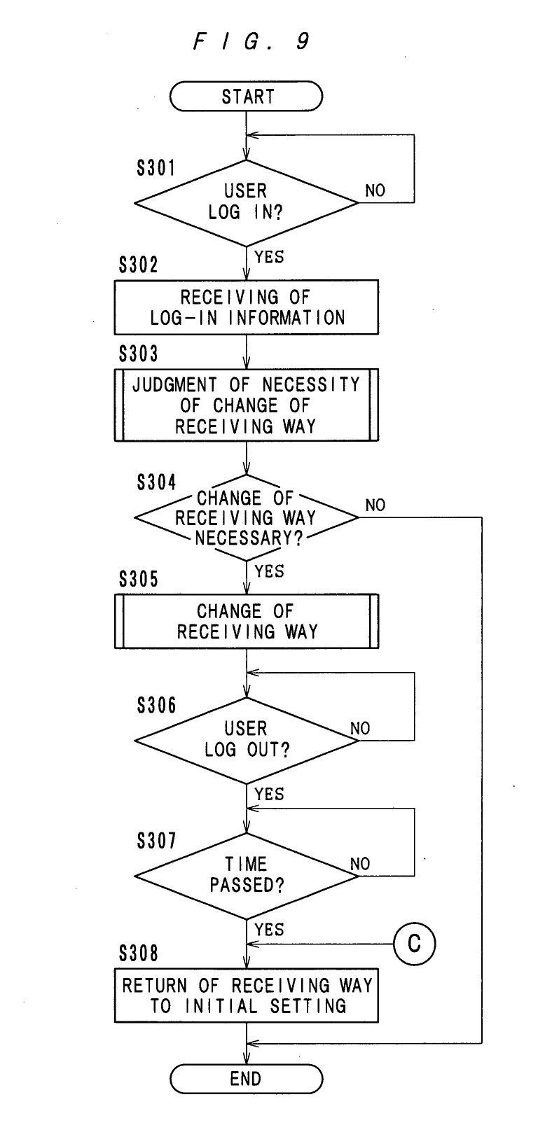

FIGS. 6a to 6d are illustrations showing the registration information. FIG. 6a shows exemplary registration information inputted into the MFP 101. FIG. 6b shows exemplary registration information inputted into the MFP 102. FIG. 6c shows exemplary registration information inputted into the MFP 103. FIG. 6d shows exemplary registration information inputted into the MFP 104.

In this embodiment, the registration information on each user includes a number, the user ID and private information. The private information includes information on privacy, an address note, information on panel settings, authentication information and history information. The information on privacy includes, for example, information on the department the user belongs to, the e-mail address of the user, the user's face data obtained by taking a photo of the user and information on the user's way of receiving data, etc.

Now, information on a user's way of receiving data is described. FIG. 7 shows information on the way of receiving data of the user David. The way of receiving data means how to process image data, including document data, text data, etc., for example, when image data are sent to the user David or when the user David makes an access to one of the MFPs and makes image data by reading a document image at the scanning section 13. A user can input one or more optional ways of receiving image data, and one of the ways is designated as an initial setting for his/her way of receiving data. In FIG. 7, four optional ways are inputted, and one of the ways is designated as the initial setting. The user can change the initial setting arbitrarily.

The information on a user's way of receiving data includes the user ID, numbers showing respective optional ways, a mark showing the initial setting, kinds of transmissions, receivers, priority, receivers' addresses and other details. The kinds of transmissions are storage in a box, receiving of a printed material, receiving of an e-mail, etc. When storage in a box is designated, image data are stored in a box specified by the receiver's address. When receiving of a printed material is designated, a device specified by the receiver automatically prints out. When receiving of an e-mail is designated, image data are attached to an e-mail and sent to the e-mail address specified by the receiver's address.

When one device is designated as receivers of different kinds of transmissions, priority is set. The priority is referred to in a procedure for changing the way of receiving data, which will be described later. The details include file format, resolution, sheet size, color/monochromatic. The detailed settings are made, for example, by the user's inputs by use of the operation section 11.

Referring back to FIG. 6, the private information is described. An address note contains information on persons the user is communicable with and for example, contains identifiers, e-mail addresses, facsimile numbers, etc. of the persons.

Information on panel settings is information on screens customized by the user. Authentication information is information used for authentication of the user when the user logs in the virtual sub-network, and here, a password is used as the authentication information. However, face image data can be used as the authentication information, or otherwise, a fingerprint, a voiceprint, an iris, a venous pattern or the like may be used.

History information is data generated in the MFPs 101 to 104 when the user makes commands to the MFPs 101 and 104, and the history information includes the contents of the commands. For example, when a user makes a command for e-mail sending, history information showing that the command is for e-mail sending, showing the receiver of the e-mail and showing the content of the e-mail is generated.

Once a virtual sub-network is formed by the MFPs 101 to 104, the MFPs 101 to 104 can recognize users of which home MFPs are the MFPs 101 to 104. Therefore, when such a user logs in the virtual sub-network from one of the MFPs, it can be judged whether the user logs in from his/her home MFP. Also, when a user operates an MFP other than his/her home MFP, the user can obtain the information on his/her way of receiving data by referring to the user data stored in the MFP.

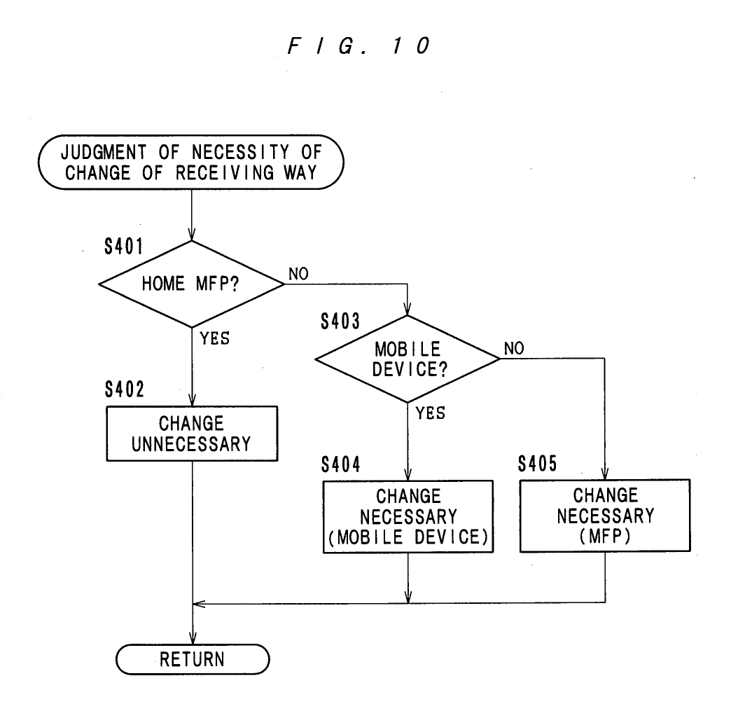

FIG. 8 shows an example of the user data. The user data includes numbers, user IDs, IDs of home MFPs and private information on individual users. In a virtual sub-network, as long as a user's home MFP is known, any of the MFPs in the virtual sub-network can receive the user's private information from the user's home MFP. Therefore, the private information on individual users does not have to be shared by all the MFPs.

### (4) Procedure for Changing the Way of Receiving Data

In the virtual sub-network formed as described above, a procedure for changing a user's way of receiving data is described. In the following, a case wherein the user David is to change his way of receiving data when he is to receive image data addressed to him or he generated by using the scanning section 13 is described.

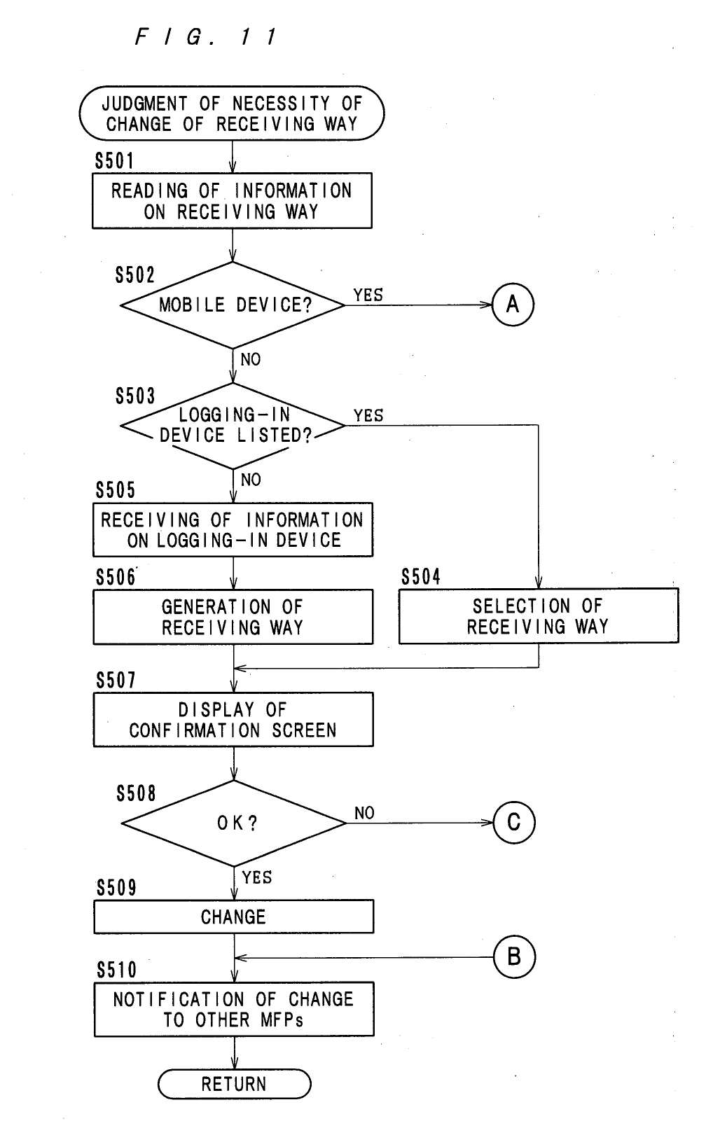

FIG. 9 is a flowchart showing an exemplary procedure for changing a user's way of receiving data. In this embodiment, the procedure shown by the flowchart is carried out, for example, when the CPU 20 of the MFP 101 activates and uses a program stored in the ROM 21. The procedure can be carried out also in the other MFPs.

FIG. 9 shows a case wherein the MFP 101 detects a user of which home MFP is the MFP 101 logging in (YES at step S301). The MFP 101 detects logs-in of users as long as the users' home MFPs are the MFP 101, whether the users log in from their home MFP (the MFP 101) or any other devices, such as any other MFPs or the cell-phones 105. Likewise, the MFP 102 detects logs-in of users as long as the users' home MFPs are the MFP 102, whether the users log in from the MFP 102 or any other devices.

When the MFP 101 detects a user logging in (YES at step S301), the MFP 101 receives log-in information (step S302). The log-in information shows the device from which the user has logged in. Then, it is judged whether a change to the user's way of receiving data is necessary (step S303).

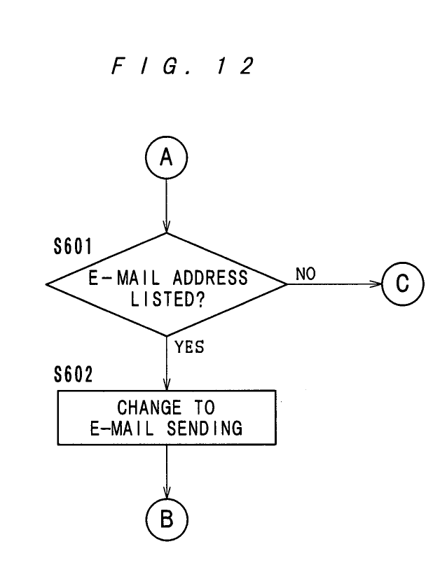

FIG. 10 is a flowchart showing an exemplary procedure for judging the necessity of a change to the user's way of receiving data. In this procedure, the logging-in device is judged whether to be the user's home MFP and whether to be a mobile device such as the cell-phone 105.

When the logging-in device is the user's home MFP (YES at step S401), it is judged that a change to the user's way of receiving data is unnecessary. Then, the processing goes back to the flowchart shown by FIG. 9.

When the logging-in device is not the user's home MFP and is a mobile device such as the cell-phone 105 (NO at step S401 and YES at step S403), it is judged that a change to the user's way of receiving data is necessary. Then, the processing goes back to the flowchart shown by FIG. 9.

When the logging-in device is not a mobile device (NO at step S403), in this embodiment, it is judged that the logging-in device is an MFP other than the user's home MFP. In this case, also, it is judged that a change to the user's way of receiving data is necessary. Then, the processing goes back to the flowchart shown by FIG. 9.

In the flowchart of FIG. 9, when a change to the user's way of receiving data is unnecessary (NO at step S304), the processing skips the following steps. When a change to the user's way of receiving data is necessary (YES at step S304), the user's way of receiving data is changed (step S305).

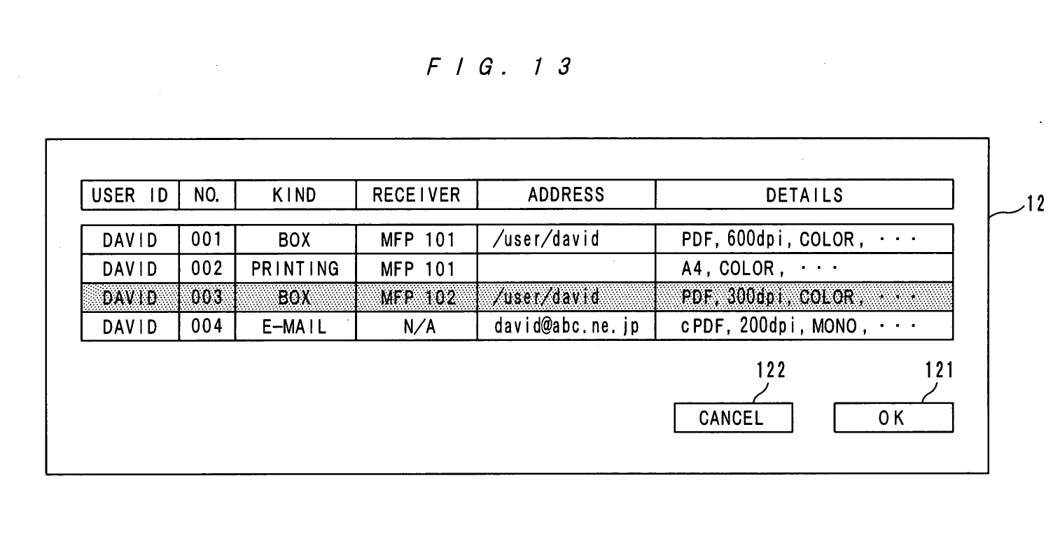

FIG. 11 is a flowchart showing an exemplary procedure for changing the user's way of receiving data. In the procedure, first, the information on the user's way of receiving data as shown by FIG. 7 is read out (step S501), and it is judged whether the logging-in device is a mobile device (step S502). When the logging-in device is a mobile device (YES at step S502), the processing goes to a flowchart shown in FIG. 12, and it is judged whether an e-mail address is included in the information on the user's way of receiving data as one of the receiving addresses (step S601). According to FIG. 7, in the optional way numbered with 004, an e-mail address is set.

When an e-mail address is included (YES at step S601), the user's way of receiving data is changed to the way designating a transmission by e-mail (step S602). Thereafter, the processing goes to step S510 shown in FIG. 10, where the MFP 101 notifies the other MFPs of the change. At this stage, a confirmation screen (which will be described later) may be displayed to promote the user to decide whether to make the change.

When no e-mail addresses are included in the information on the user's way of receiving data (NO at step S601), the processing goes to step S308 shown in FIG. 9, and the user's way of receiving data is returned to the initial setting. In this case, however, instead of returning the user's way of receiving data to the initial setting, the user's way of receiving data may be changed, for example, to the way designating storage in a box provided for the user in the user's home MFP.

Referring back to FIG. 11, when the logging-in device is not a mobile device (NO at step S502), it is judged whether the logging-in device is included in the information on the user's way of receiving data (step S503). Specifically, it is judged whether the logging-in device is listed as one of the receivers as shown in FIG. 7.

When the logging-in device is listed (YES at step S503), the way designating the logging-in device as the receiver is selected (step S504). At this time, the selection is in accordance with the priority as shown in FIG. 7.

When the logging-in device is not included in the information shown by FIG. 7 (NO at step S503), the MFP 101 obtains information on the logging-in device (step S505) and generates a receiving way (step S506). The information on the logging-in device is, for example, information on the functions of the logging-in device.

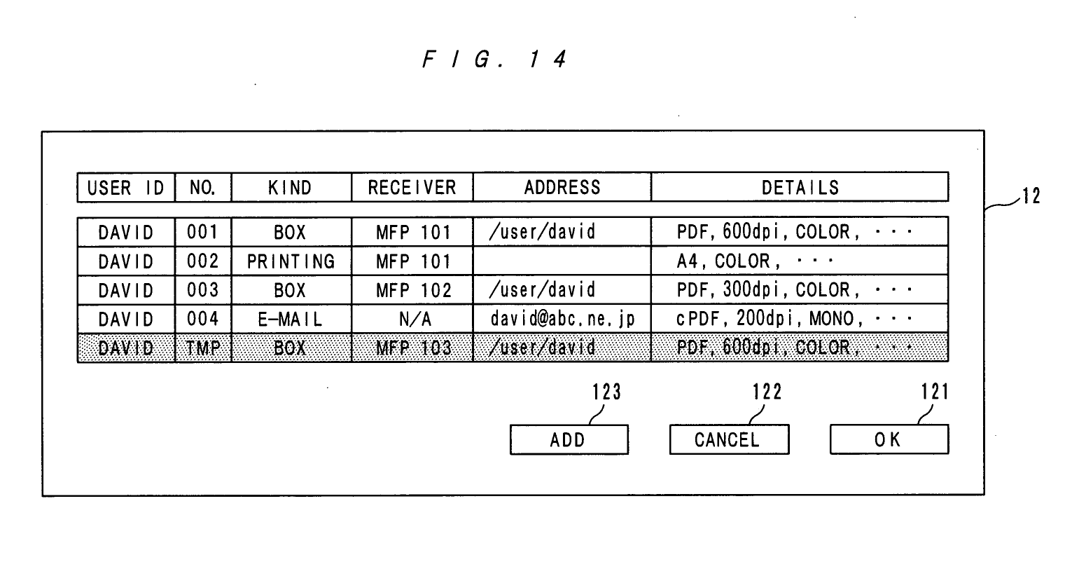

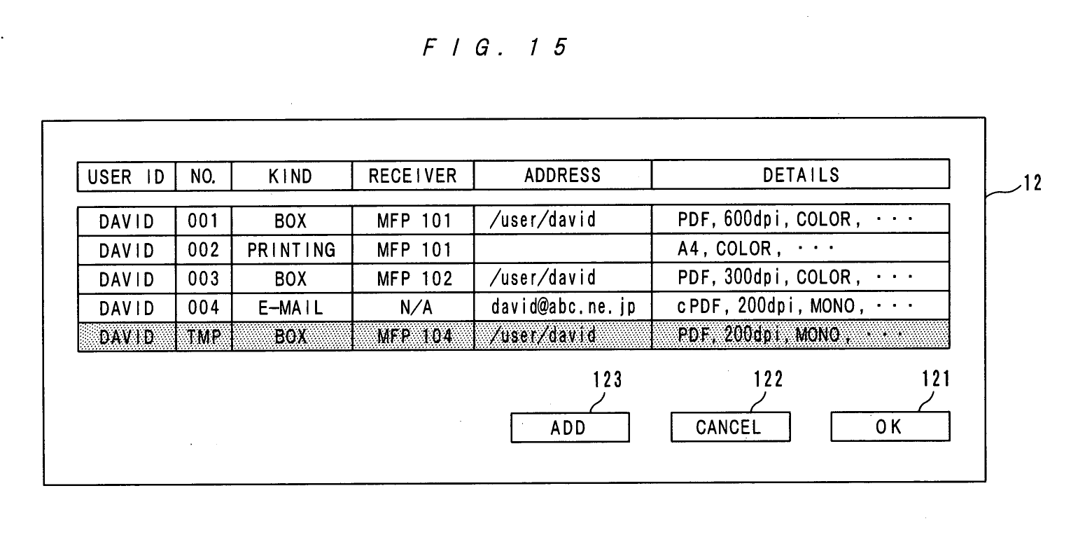

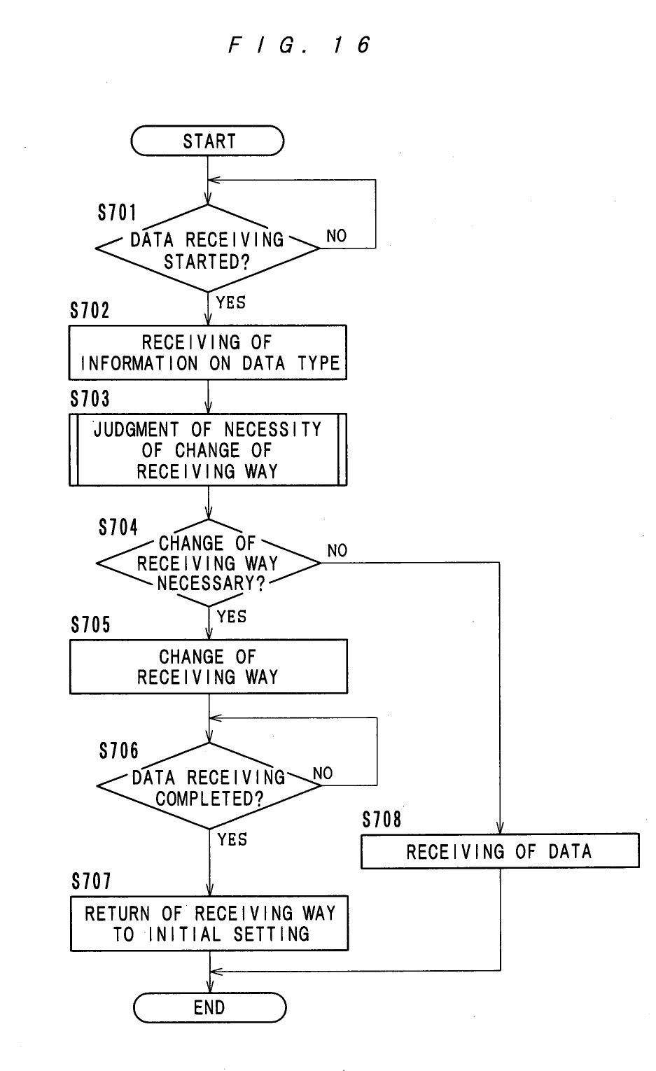

When a selection from the optional ways (step S504) or generation of a receiving way (step S506) is executed, a confirmation screen to confirm the user's opinion on the change to the user's way of receiving data is displayed (step S507). FIG. 13 shows an example of the confirmation screen displayed on the display section 12 when a selection from the optional ways is executed at step S504. The confirmation screen of FIG. 13 shows that the user David has logged in from the MFP 102 while the initial setting for his way of receiving data is the way numbered with 001. The hatching in FIG. 13 shows the selected way. Also the hatching in FIGS. 14 and 15 shows the selected ways.

In this example, because the logging-in device is included in the information on the user's way of receiving data, as shown by FIG. 13, one of the optional ways designating the logging-in device as the receiver is selected. Then, when the user is pressed down the “OK” button 121 (YES at step S508), the user's way of receiving data is changed to the selected way (step S509). Then, the MFP 101 notifies the other MFPs of the change (step S510).

On the other hand, when the user presses the “CANCEL” button 122 (NO at step S508), the processing goes back to step S308, where the user's way of receiving data is returned to the initial setting.

FIG. 14 is an example of the confirmation screen displayed on the display section 12 when generation of a receiving way is executed at step S506. This is a case wherein the user David has logged in from the MFP 103 while the initial setting for his way of receiving data is the receiving way numbered with 001.

In this case, the logging-in device MFP 103 is not included in the information on David's way of receiving data, and a new receiving way is generated. Specifically, the new receiving way is generated after the model of the receiving way numbered with 001. By using a model, it is possible to generate a new receiving way which almost satisfies the user's desires. At this time, the MFP 101 refers to information on the functions of the logging-in device, MFP 103. If the MFP 103 has the same functions with the MFP 101, the detailed settings of the new receiving way can be the same with those of the receiving way 001. However, if a box for the user David is not in the MFP 103, for example, a public box may be set as the receiving address. The user can change the box arbitrarily.

When the user presses the “OK” button 121 (YES at step S508), the user's way of receiving data is changed to the newly generated way (step S509). Then, the MFP 101 notifies the other MFPs of the change (step S510). When the user presses the “CANCEL” button 121 (NO at step S122), the processing goes back to step S308 in FIG. 9, where the user's way of receiving data is returned to the initial setting. In the example of FIG. 14, the screen further includes an “ADD” button 123, and when the user presses the “ADD” button 123, the newly generated way is added to the information on the user's way of receiving data (shown by FIG. 7) as a new optional way 005.

FIG. 15 shows another example of the confirmation screen displayed on the display section 12 when generation of a receiving way is executed at step S506. This is a case wherein the user David logs in from the MFP 104 while the initial setting for his way of receiving data is the receiving way numbered 001.

In this case, referring to the information on the functions of the MFP 104, the details of a newly generated receiving way are set differently from those of the initial setting, that is, the way 001. (In the newly generated receiving way, PDF, 200 dpi, monochromatic, etc. are set.) The description above is about generation of a receiving way in a case wherein the initial setting is the receiving way 001. However, for example, when the initial setting is the receiving way 002, a receiving way is generated after the model of the receiving way 002. In this case, therefore, a newly generated receiving way will designate receiving of a printed material.

After completing the above-described procedure for changing the user's way of receiving data, the processing goes back to the flowchart shown by FIG. 9. In this embodiment, when a specified time has passed since the user's log-out (YES at step S306 and YES at step S307), the user's way of receiving data is returned to the initial setting (step S308). However, the return to the initial setting may be executed at the time of the user's log-out or may be executed when a specified time has passed since the change to the user's way of receiving data.

### Second Embodiment

In the first embodiment above, depending on the logging-in device from which a user logs in, the user's way of receiving data is changed. However, depending on the attributes of image data, the user's way of receiving the data may be changed. For example, when confidential data are to be received, it is not good that the data will be automatically printed out.

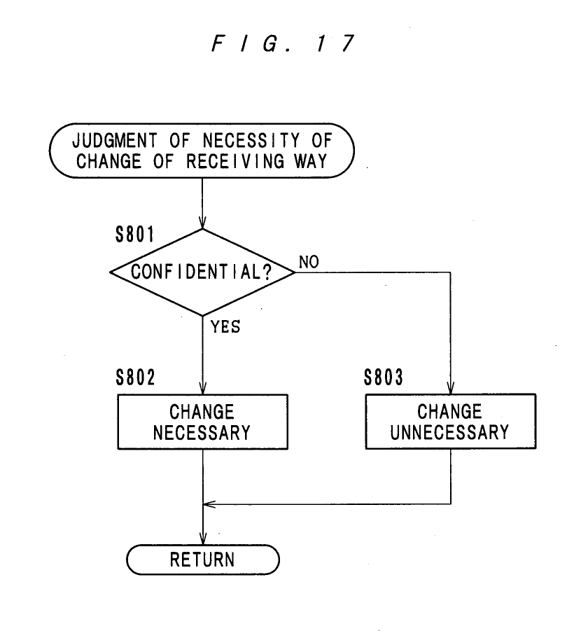

FIG. 16 is a flowchart showing an exemplary procedure according to the second embodiment. In this embodiment, when an MFP starts receiving data (YES at step S701), the MFP obtains information on a data type (step S702). Then, depending on the data type, it is judged whether a change to the user's way of receiving data is necessary (step S703).

FIG. 17 is a flowchart showing an exemplary procedure for judging the necessity of a change to the user's way of receiving data. In this embodiment, it is judged whether the data to be received are confidential (step S801). When the data are confidential (YES at step S801), it is judged that a change to the user's way of receiving data is necessary (step S802). When the data are not confidential (NO at step S801), it is judged that a change to the user's way of receiving data is unnecessary (step S803).

Referring back to FIG. 16, when a change to the user's way of receiving data is necessary (YES at step S704), the user's way of receiving data is changed (step S705). For example, when some items of the initial setting are not suited for receiving of the data in view of the attributes of the data, appropriate changes are made to the unsuited items.

For example, in a case wherein the initial setting designates print-out, facsimile or storage in a public box, when the MFP is to receive confidential data, the kind of transmission may be changed to storage in a box for the user (to which any other users are inaccessible) or to transmission by e-mail.

After changing the user's way of receiving data, when receiving of the data is completed (YES at step S706), the user's way of receiving data is returned to the initial setting (step S707). When it is judged that a change to the user's way of receiving data is unnecessary (NO at step S704), data are received under the initial setting (step S708).

According to the second embodiment, the condition of judgment of the necessity of a change to the user's way of receiving data is not limited to whether the data are confidential and may be whether the data are urgent, whether the data are a document with a large number of pages, or the like. For example, when urgent data are to be received while the initial setting designates storage in a box, the kind of transmission may be changed to transmission by e-mail. Also, when data including a number of pages larger than a specified number are to be received while the initial setting designates print-out, the kind of transmission may be changed to storage in a box, or the details of printing may be changed to duplex printing, two-in-one printing or the like.

### Modifications

As well as the embodiments described above, the following modifications are possible.

### Modification 1

The initial setting for the user's way of receiving data may be changed, for example, depending on whether image data are received from another MFP or are generated at the scanning section 13. For this change, a flag for showing a case of using the scanning section 13 may be included in the information on the user's way of receiving data as shown by FIG. 7.

### Modification 2

According to the first embodiment above, when a user logs in from a mobile device such as the cell-phone 105 and when an e-mail address is included in the information on the user's way of receiving data, the user's way of receiving data is changed to transmission by e-mail. However, a flag for showing a case wherein a user logs in from a mobile device may be included in the information on the user's way of receiving data as shown by FIG. 7.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An image processing apparatus comprising:
an image data receiving section for receiving image data;
a storage section stored with processing information in connection with individual users, the processing information in connection with each user including one or more optional ways of processing the image data and specifying one of the optional ways as an initial setting for the user's way of processing the image data;
a judging section for judging whether it is necessary to change the way of processing the image data from the initial setting, regardless of a command from the user; and
a changing section for changing the way of processing the image data from the initial setting when the judging section judges that it is necessary to change the way of processing the image data.

2. An image processing apparatus according to claim 1, further comprising a log-in detecting section for detecting a user logging in said image processing apparatus or another image processing apparatus connected to said image processing apparatus via a network,
wherein, when a user logs in an image processing apparatus other than an image processing apparatus previously specified for the user, the judging section judges that it is necessary to change the way of processing the image data from the initial setting.

3. An image processing apparatus according to claim 1, further comprising an attribute information receiving section for receiving attribute information on attributes of the image data received by the image data receiving section,
wherein the judging section judges from the attribute information whether it is necessary to change the way of processing the image data from the initial setting.

4. An image processing apparatus according to claim 3, wherein the changing section changes the way of processing the image data from the initial setting to a more suited way in accordance with the attribute information.

5. An image processing apparatus according to claim 1, wherein the changing section selects one, other than the initial setting, from the optional ways included in the processing information and changes the way of processing the image data to the selected way.

6. An image processing apparatus according to claim 1, wherein:
each of the optional ways included in the processing information contains a plural number of items; and
the changing section changes the way of processing the image data to a way by making a change to at least one item of one of the optional ways.

7. An image processing apparatus according to claim 6, wherein an entering section for entering the way to which the way of processing the image data is changed into the processing information as a new optional way.

8. An image processing apparatus according to claim 1, further comprising a logging-in device information receiving section for receiving information on a type of a logging-in device from which a user logs in,
wherein when the logging-in device is a mobile device, the judging section judges that it is necessary to change the way of processing the image data from the initial setting.

9. An image processing apparatus according to claim 8, wherein when the logging-in device is a mobile device, the changing section changes the way of processing the image data to a way of sending e-mail.

10. An image processing apparatus according to claim 1, wherein after changing the way of processing the image data from the initial setting, the changing section returns the way of processing the image data to the initial setting when a specified condition is satisfied.

11. An image processing apparatus according to claim 10, wherein when the user logs out, the changing section returns the way of processing the image data to the initial setting.

12. An image processing apparatus according to claim 10, wherein when a specified time has passed since a change of the way of processing the image data, the changing section returns the way of processing the image data to the initial setting.

13. An image processing apparatus according to claim 10, wherein when a specified time has passed since a log-out of the user, the changing section returns the way of processing the image data to the initial setting.

14. An image processing apparatus according to claim 1, wherein the image data receiving section receives image data from an exterior device via a network.

15. An image processing apparatus according to claim 14, wherein the one or more optional ways of processing the image data for each user are one or more optional ways of processing the image data sent from the exterior device to the user.

16. An image processing apparatus according to claim 1, further comprising a scanner,
wherein the image data receiving section receives image data which the scanner generated by reading a document image.

17. An image processing apparatus according to claim 16, wherein the one or more optional ways of processing the image data for each user are one or more optional ways of processing the image data which the scanner generated by reading a document image.

18. A software program stored on a computer readable medium to be installed in a device with a processor,
wherein said device comprises a storage section stored with processing information in connection with individual users, the processing information in connection with each user including one or more optional ways of processing image data and specifying one of the optional ways as an initial setting for the user's way of processing image data,
wherein said software program causes said processor to execute processing comprising:
a step of judging whether it is necessary to change the way of processing image data from the initial setting, regardless of a command from the user; and
a step of changing the way of processing image data from the initial setting when the judging section judges that it is necessary to change the way of processing image data.
